(19) United States
(12) Patent Application Publication
(10) Pub. No.: US 2024/0232888 A1
(43) Pub. Date: Jul. 11, 2024

(54) SYSTEM AND METHOD FOR ELECTRONIC PAYMENTS USING TRANSACTION IDENTIFIER CODES AND GROUP IDENTIFICATION CODES

(71) Applicant: Millind Mittal, Saratoga, CA (US)

(72) Inventor: Millind Mittal, Saratoga, CA (US)

(21) Appl. No.: 18/617,142

(22) Filed: Mar. 26, 2024

Related U.S. Application Data
(63) Continuation-in-part of application No. 17/478,950, filed on Sep. 19, 2021, now abandoned.
Application No. 17/478,950 is a continuation-in-part of application No. 16/240,300, filed on Jan. 4, 2019, now abandoned.
Application No. 16/240,300 is a continuation-in-part of application No. 14/944,986, filed on Nov. 18, 2015, now abandoned.
Application No. 14/944,986 is a continuation-in-part of application No. 14/302,423, filed on Jun. 12, 2014, now abandoned.
Application No. 14/302,423 is a continuation-in-part of application No. 13/325,291, filed on Dec. 14, 2011, now abandoned.
(60) Provisional application No. 62/081,309, filed on Nov. 18, 2014.
(60) Provisional application No. 62/180,503, filed on Jun. 16, 2015.
(60) Provisional application No. 62/181,723, filed on Jun. 18, 2015.
(60) Provisional application No. 61/836,152, filed on Jun. 18, 2013.
(60) Provisional application No. 61/836,232, filed on Jun. 18, 2013.
(60) Provisional application No. 61/834,582, filed on Jun. 13, 2013.
(60) Provisional application No. 61/559,118, filed on Nov. 13, 2011.

(51) Int. Cl. G06Q 20/40; G06Q 20/32

(52) U.S. Cl. CPC G06Q 20/4015; G06Q 20/325

(57) ABSTRACT

Systems and methods for making payments are described. The method includes transmitting with a first telecommunications device a request for a transaction identification (TID), a payment amount for a financial transaction, and first geographical location data to a payment server. The payment server generating and transmitting the TID to the first telecommunications device. The first telecommunications device communicating the received TID to a second telecommunications device, and the second telecommunications device transmitting the received TID and second geographical location data to the payment server. The payment server comparing the received TID to the generated TID and the first to the second geographical location data, and in response to a match, transmitting back to the second telecommunications device a payment confirmation request. The second telecommunications device transmitting an authorization order to the payment server to release the payment amount to the first telecommunications device.

### CROSS-REFERENCE TO RELATED APPLICATIONS

This application is a continuation in part of U.S. patent application Ser. No. 17/478,950, filed on Sep. 19, 2021, which is a continuation in part of U.S. patent application Ser. No. 16/240,300, filed Jan. 4, 2019, which is a continuation in part of U.S. patent application Ser. No. 14/944,986, filed on Nov. 18, 2015, which claims the benefit of U.S. Provisional Appl. No. 62/081,309, filed on Nov. 18, 2014, U.S. Provisional Appl. No. 62/180,503, filed Jun. 16, 2015, U.S. Provisional Application No. 62/181,723, filed Jun. 18, 2015, and is a continuation in part of U.S. patent application Ser. No. 14/302,423, filed on Jun. 12, 2014, which claims the benefit of U.S. Provisional Appl. No. 61/836,152, filed on Jun. 18, 2013, U.S. Provisional Appl. No. 61/836,232, filed on Jun. 18, 2013, U.S. Provisional Appl. No. 61/834,582, filed on Jun. 13, 2013, and is a continuation in part of U.S. patent application Ser. No. 13/325,291, filed on Dec. 14, 2011, which claims the benefit of U.S. Provisional Appl. No. 61/559,118, filed on Nov. 13, 2011, the entire disclosure of each of which is hereby incorporated by reference.

### FIELD OF TECHNOLOGY

The present disclosure relates to computerized methods of payment in commerce and ecommerce settings.

### BACKGROUND

As electronic financial transactions have expanded, exemplified by the widespread use of credit cards for nearly all types of both direct and electronic commerce, so too has the risk of fraudulent financial transactions. Although much prior effort in security has been devoted to foiling sophisticated “man in the middle” attacks through the use of secure and encrypted communications channels, there is almost no defense against low-technology fraud. For example, an unscrupulous store clerk can write down a customer's credit card information, and subsequently use the customer's credit card information to make unauthorized charges.

In a face-to-face transaction, a customer can at the very least watch the clerk during the transaction, and potentially identify the clerk later if there is fraudulent activity detected. In contrast, when the transaction takes place over the phone or over the internet, the customer cannot watch the clerk and/or identify the clerk in the event of a fraudulent activity.

As a result, many individuals are leery of engaging in long-distance electronic financial transactions. Although many financial agencies, such as credit card companies, have established processes that allow them to detect fraudulent activities and reimburse their customers for fraudulent transactions, the reimbursement process can be slow and distressing for the customers. Further, fraudulent activity detection and reimbursement services are not inexpensive, and may ultimately increase the cost of credit card ownership for the credit card holders via, for example, indirect credit card fee charges to merchants and consumers.

In an effort to conceal and protect the financial information of consumers and customers alike, there have been a number of efforts to devise various types of electronic payment systems, exemplified by PayPal and Ericsson IPX mobile payments. In one such scheme, exemplified by PayPal, the payer (i.e., the customer) creates an account with a PayPal network payment server that is generally accessed through the network payment server's client interface (e.g., the PayPal payment server's web browser or application, or a PayPal linked auction website such as eBay, and the like). The PayPal network payment server links the payer's account to the payer's credit card, bank account, or other existing source of funds, and generates a PayPal identification (ID), which is often based on the customer's email. The payer can then pay with his/her PayPal ID instead of providing his/her real financial information.

The PayPal system is useful for online purchases, but since the PayPal account information (e.g., the user's email, the user's PayPal account ID) continues to be both persistent and sensitive, there are still security concerns. For example, malicious websites may present a fake (e.g., dummy) “PayPal look-alike” site for accepting payments to collect PayPal account information. Separately, systems, such as the PayPal system, requires from its customers to enter his/her account information credentials for every financial transaction, which may be both inconvenient and non-secure. Furthermore, such web-based systems are not suitable for making in-store purchases—e.g., a customer would not want to sign into his/her PayPal account from a merchant's device.

In alternative approaches used by some mobile payment service providers, such as the Ericsson IPX for online transactions, the payer (i.e., customer) provides a mobile phone number to the payee (i.e., the merchant), which then presents the phone number to the Erickson payment system. In response, the payment system provides the payer with a passcode number (PIN), which the payer provides to the merchant (payee). Upon receiving the PIN, the payee (merchant) releases the on-line goods/services. The payment funds for the transaction come from the payer's mobile phone bill.

A drawback of this approach is that the payer needs to share his/her personal information (e.g., a phone number) with the payee's (merchant) website. Separately, this process can be inconvenient for the payer because the payer has to first enter information (e.g., his/her phone number) to the payee's website and then, read the PIN from his/her cell phone and enter the PIN back to the payee's website.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### BRIEF SUMMARY

The subject matter described herein relates to a payment method and system that use a temporary (e.g., transient) transaction “identifier” or code (thereafter “TID”) in combination with one or more attributes to uniquely identify a financial transaction. In some embodiments, the one or more attributes can be a timestamp for the TID, a time of the transaction, a group identification, a payer associated identifier and a payment server provided identifier combination, location coordinates, some other user identification, a user defined characteristic, or any combinations thereof. In some examples, there can be two types of attributes. The first type can be provided by both interacting parties (e.g., the payer and the payee) while the second type can only be provided by one of the parties. By way of example and not limitation, the first type of attributes can include the timestamp of the TID or the time of the transaction and the location coordinates, while the second type of attributes can include the payer associated identifier and the payment server identifier combination.

In some implementations, the TID and the attribute combination can be used once within a predefined time interval. However, outside the predefined time interval, the TID may be recycled (e.g., re-used) and combined with a different attribute or attributes for another financial transaction. In some embodiments, the TID allows a payment (e.g., a financial transaction) to be linked to a customer's (e.g., the payer's) financial information so that the TID, and not the customer's personal and/or sensitive financial information, is used by the customer to make transactions with one or more merchants (e.g., payees) or other providers of goods and/or services.

In some implementations, depending on the one or more attributes used with the TID, the length of the TID may be shortened so that the TID can be conveniently communicated between humans. For example, the TID can be a code (e.g., numeric or alphanumeric) with 10 or fewer characters (e.g., with four characters). In some embodiments, the TID can be human readable, as opposed to being a machine readable code, such as a universal product code (UPC) or a quick response (QR) code. Additionally, the TID may be valid for a single transaction, or for a predetermined period of time, such as a week, a day, an hour, or even a minute. According to some embodiments, the shorter the period of time for which the TID is valid, the fewer the number of unique transactions that can be supported by the TID. TIDs that are valid within shorter periods (e.g., within hours or minutes) provide higher security, but may be less convenient for some users. In contrast, TIDs that are valid for a longer periods (e.g., within days or weeks) can be less secure, but potentially more convenient for some users. Therefore, the validity period for a TID can be adjusted to achieve a good tradeoff between security and convenience, according to some embodiments.

In some embodiments, a TID may be obsolete or have a NULL value in scenarios where an attribute provided by the payer is combined with a server provided identifier to produce a globally unique combination. The globally unique combination can be used by the payment server to uniquely bind the active transaction to the payer and the payee without the need for a TID.

In some implementations, the time period during which a TID is valid or active (i.e., its validity period) can be a bounded time period featuring a start time and an end time. In some embodiments, a payee may determine a future start time and end time for the bounded time period, thereby determine the length of time for which a TID is valid or active—e.g., the validity period. Advantageously, the payee can have control over every future start time and end time of the bounded time period. In some implementations, the start and end times of the validity period (during which a TID is valid or active) may be automatically set by the disclosed payment server (e.g., in the form of default values). In some embodiments, the start time of the validity period can coincide with the time the TID is first generated by the payment server (e.g., in the form of a timestamp) while the end time may be determined either by the payment server as a default value or by the payee.

According to some embodiments, the method disclosed herein is a computerized payment method based on short, temporary (e.g., transient), TID numbers or codes that conceal the payer's (i.e., the customer's) financial and personal information. The payer will initially register with a payment server a source of funds and a payer telecommunications device with a unique identification (ID) (e.g., with a phone number). Because a phone number can uniquely identify a payer, no third party verification is required by the payment server during the registration phase. This means, the payment server does not need to verify the payer via his/her home address, photo ID, or other documentation beyond the payer's associated phone number, through which the payer may be reached at any time via secure text messaging. Once a payee (merchant) and the payer agree on a financial transaction amount, the payee may request a TID from the payment server that corresponds to the agreed upon transaction amount. Subsequently, the payment server generates and transmits (e.g., sends via a direct electronic transmission, or through one or more intermediate servers) the TID to the payee.

The payee communicates the received TID to the payer using a variety of methods (e.g., with a visual display from a payee telecommunications device, electronic communication from the payee telecommunications device to the payer telecommunications device, verbal communication between the payee and payer, and so on). The payer relays (transmits) with his/her payer telecommunications device the TID back to the payment server, which, upon verification of the TID, authorizes the transaction and releases the funds to the payee. In some embodiments, the payment server can store all financial transaction details in persistent records for auditing purposes. Advantageously, in the above process, the transaction's security is substantially enhanced because the merchant never gets direct access to the customer's financial account or personal information.

In some embodiments, the payee may be willing to accept a variety of different (multiple) payment services that could be utilized for payments, including TID payments from multiple (different) payment servers, possibly run by different organizations. In this scenario, when the payer is ready to indicate to the payee that he/she is ready to pay, the payer can also communicate a payer's payment server identifier to the payee. This payment server identifier may for example, be the name of the payment service associated with the payment server, the network address of the payment server, or other forms of identification suitable for establishing communication between the payee and the payment server. The payee can then use the identified payment server for the transaction.

In some embodiments, the payee's request for a TID may be made via an intermediate server. In this scenario, along with the amount to be charged, the payee can also provide to the intermediate server the payment server identifier as provided by the payer.

According to some embodiments, the payee telecommunications device can include at least one processor, memory, a global positioning system (GPS) or pre-programmed GPS coordinates, payee software (e.g., an application), and a display (e.g., bitmapped liquid crystal display or other type of computer-controlled display). In some implementations, the payee telecommunications device can be connected directly to the payment server through a telecommunications network. In additional implementations, the payee telecommunications device can be connected, through the telecommunications network, to an intermediate server, which can act as a payment collection server and can run on a separate payment collection service. This payment collection server, which further acts as the payee's agent, can be separate from the payment server.

In some embodiments, instead of the payee requesting the TID, the payment collection service may request the TID from the payment server. In this situation, the payment collection service acts on behalf of the payee as the payee's agent that receives the TID. Thus, and with respect to the payment server, the payee's agent can be viewed as the payee. Accordingly, at the end of the transaction, the payment server will instead release the payments to the payment collection service. Subsequently, the payment collection service can store the payment on behalf of the payee, or release the payment to the payee. The principal payee, who is represented by the agent payee, is referred to as the “primary payee”. Therefore, the disclosed method and system can seamlessly work with primary payees that use payment collection services, such as PayPal, to enhance the security of those systems.

With the payee provided TID method and system disclosed herein, consumers can feel free to order products and services either directly (i.e., face to face, such as in a coffee shop), or remotely (e.g., via phone or internet) knowing that the transient TID that is used for the financial transaction cannot be used against them for unauthorized purchases. More specifically, the methods and systems disclosed herein protect the customer's sensitive personal and financial information because the transaction ID is not bound, linked, or otherwise associated with the payer's financial account until the payer enters the TID (usually through a secure communication channel) to the payment server. An additional advantage of the disclosed method is that the payer can further ensure that the payment amount that the payment server releases to the payee for a particular purchase is the payment amount that the payer had previously agreed to pay. This is because the payment server can only obtain electronic authorization from the payer for that specific payment amount. In some embodiments, and as an additional security measure, the payment server may send confirmation messages, such as text messages to the payer's mobile phone or a confirmation email to the payer's email address at the conclusion of the transaction.

One of the benefits of the disclose method (e.g., in comparison to existing methods) is that the transactions between payers and payees can be simpler, more convenient, and secure. For example, with the method and system disclosed herein, the payer (i.e., the customer) can avoid entering his/her credit card information to the payee's (i.e., the merchant's) web-portal or website for the purposes of completing a transaction for a product or service or handout its credit card or debit card. Instead, the payment may proceed with the use of a TID, which is advantageously devoid of any financial and personal information. This is because, once the TID is provided by the payee (merchant) and validated by the payer (e.g., via a mobile payment application on the payer telecommunications device), the payer may no longer need to interact with the payee or disclose any of his/her financial information. Therefore, the present method and system provide a high degree of security for the payer's financial and personal information by eliminating the need for the payer to provide any sensitive information to the payee. Additionally, the disclosed method does not require the payer to provide any additional form of identification (i.e., third party identification, such as photo ID, social security number, and the like) to a payment server beyond his/her mobile phone number, which is uniquely tied to the payer.

Although the TID of the disclosed method protects the payer's identity and financial accounts to a much greater extent than existing methods, the payment server can nonetheless also comply with all financial regulations regarding the traceability of financial transactions. This is because the payment server maintains complete records of the payer's (customer's) identification, the payee (merchant's) identification, as well as the funding amounts, the time of the transaction, and the source of funds used.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present description. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present disclosure.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE SEVERAL VIEWS OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1A schematically describes a system for making electronic payments with transient transaction identifier (TID) using a payment server, in accordance to some embodiments.

FIG. 1B depicts a variation of the system shown in FIG. 1A, in accordance to some embodiments.

FIG. 2 schematically shows the process for linking a payer's financial information to a payer telecommunications device using the system of FIG. 1A, in accordance to some embodiments.

FIG. 3 schematically describes the interactions between a payer and a payee with a payment server prior to a financial transaction involving an item for purchase, in accordance to some embodiments.

FIG. 4 schematically describes a method for making electronic payments with a transient TID using the systems and the processes described in-part in FIGS. 1A-1B, 2, and 3, in accordance to some embodiments.

FIG. 5 schematically describe a process of authorizing a transaction and transferring funds to a payee as part of a method for making electronic payments with TID codes, in accordance to some embodiments.

FIG. 6 shows an embodiment that uses location data to enable shorter length TID codes as part of a method for making electronic payments with TID codes, in accordance to some embodiments.

FIG. 7 schematically represents a method for making electronic payments with short, transient TID codes to further account for a group identification (GID), including globally unique group identification (GUGID), in accordance to some embodiments.

FIG. 8 schematically represents a method for making electronic payments with a designated delegate, in accordance to some embodiments.

### DETAILED DESCRIPTION

A computerized payment system and method is disclosed herein that are based on short, temporary (e.g., transient), transaction identification (TID) numbers or codes, which protect the security of the payer's (i.e., the customer's) financial accounts and personal information.

It will be appreciated that, for simplicity and clarity of illustration, where considered appropriate, reference numerals may be repeated among the figures to indicate corresponding or analogous elements. In addition, numerous specific details are set forth in order to provide a thorough understanding of the exemplary embodiments described herein. However, it will be understood by those of ordinary skill in the art that the exemplary embodiments described herein may be practiced without these specific details.

In various examples described herein, TIDs are assumed to be temporary (e.g., transient) that expire at some point (when the limited time period has passed), unless otherwise specified. Accordingly, TIDs may be reused for a different transaction after their respective time period has expired. In this context, the TID can be analogous to a telephone number, where the limited time period corresponds to an area code and the TID corresponds to the local telephone number. It is therefore the combination of the area code (identified limited time period) and telephone number (TID) that uniquely identify a particular telephone (financial transaction). However, in a more general sense, and within the spirit of the example provided above, one or more attributes may correspond to the “area code” and the “local telephone number” may correspond to the TID, both of which are used to uniquely identify a person's telephone number (i.e., a financial transaction).

According to some embodiments, the payment method described herein can be summarized as follows. The payee initially registers a source of funds and a payer telecommunications device having a unique device ID with a payment server. Once a payee (i.e., the merchant) and the payer have agreed on a financial transaction amount, the payee requests a TID from the payment server for that amount. In the event that the request for the TID is made via an intermediate server of a payment collection service, the payee, along with the amount to be charged, will also transmit a payment server identifier to the intermediate server. Once the information from the payee is received by the payment server, the payment server transmits to the payee the TID, which the payee then forwards or communicates to the payer. The payer relays, via his/her payer telecommunications device, the TID back to the payment server, which validates the transaction. Once the transaction is validated, the payment server may further request approval from the payer to make the payment for the transaction—for example, by sending the transaction information to the payer's telecommunications device and requesting confirmation from the payer (e.g., via text message) to release the funds to the payee. In some embodiments, the payment server preserves all the transactional records for auditing purposes. Advantageously, the payee (e.g., the merchant) never gets direct access to the customer's financial account and personal information—which enhances the security of the disclosed method.

In situations where a payment collection service is used by the payee, the request for a TID can be made by the payment collection service, which can be linked to a payee telecommunications device. Once validation of the TID is made by the payment server, the payment server may release the payment directly to the payment collection service. In some examples, the payment collection service may either store the payments on behalf of the payee or release the payment to the payee.

### Time Bounded Implementations

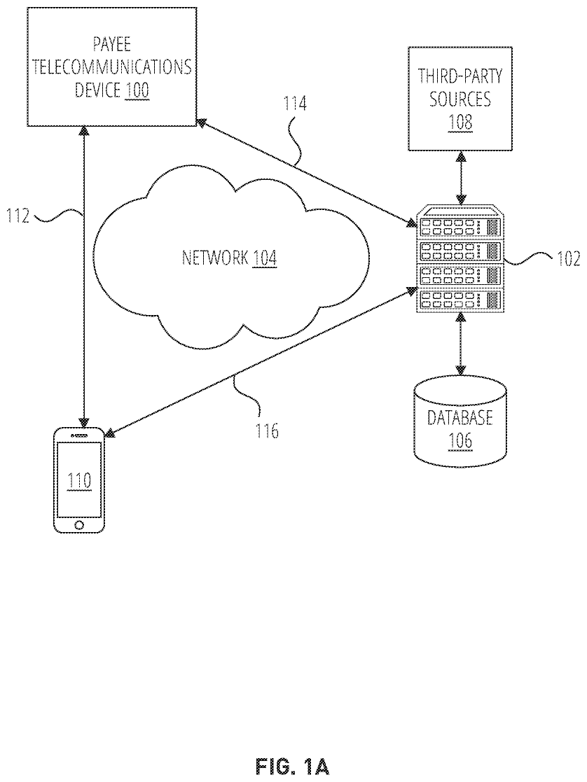

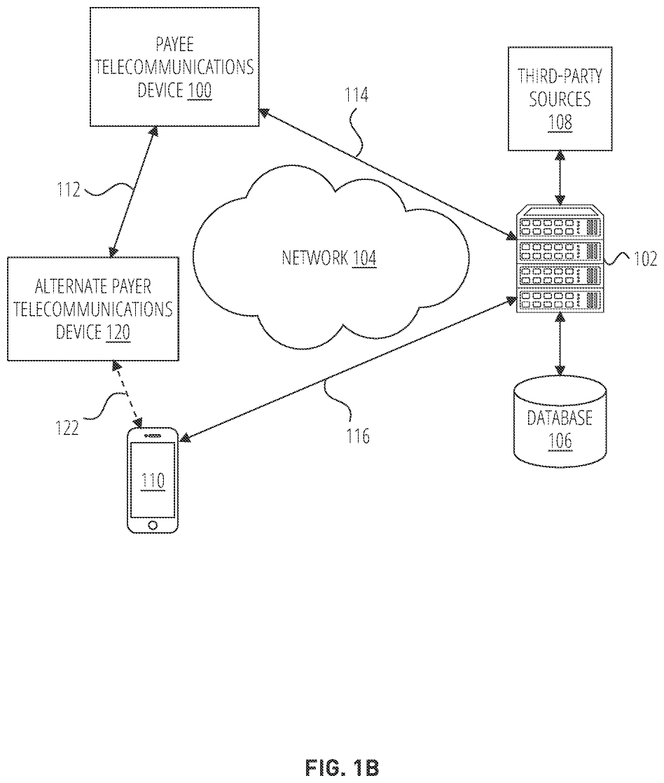

Reference is now made to FIG. 1A, which schematically shows a system for making electronic payments with transient TID codes using a payment server 102, according to some embodiments. In the system of FIG. 1A, a payee (not shown) can communicate with payment server 102 via a payee telecommunications device 100 through a network 104 as indicated by a bidirectional communication link 114. According to some embodiments, the payee telecommunications device 100 may be capable of establishing a connection to payment server 102 using one or more networks (e.g., an intranet network, an extranet network, a telecommunications network, any suitable network, or any combinations thereof), collectively referred to herein as network 104. By way of example and not limitation, payee telecommunications device 100 and payment server 102 may be communicatively coupled (e.g., connected) to network 104 via any suitable means of wired and/or wireless communication protocols, such as Ethernet, Wi-Fi, LTE, 3G, 4G, 5G, and the like, or any combinations thereof. By way of example and not limitation, the payee telecommunications device 100 can be a simple dumb phone, a smartphone, a terminal computer, a tablet, a desktop computer, a laptop computer, a point of sale (POS) system, or another suitable device capable of communicating directly or indirectly with payment server 102 to perform the functions of the method and system described herein. Aside from its hardware, the payee telecommunications device 100 can also include appropriate software (e.g., a software application) that allows the payee telecommunications device 100 to communicate with the payment server 102. For example, the payee telecommunications device 100 may be equipped with an operating system and a browser or a software application. In some implementations, the payee telecommunications device 100 can be identified by a unique merchant ID so that the payment server 102 can uniquely identify the payee telecommunications device 100.

Similarly, the payment server 102 can include any appropriate combination of hardware and software to perform the operations described herein. For example, payment server 102 can include one or more processors (e.g., central processing units (CPUs)), one or more graphics processing units (GPUs), memory (e.g., random access memory (RAM), Flash memory), appropriate software, network connection devices, and persistent memory in the form of an internal and/or external storage devices, such as database 106. By way of example and not limitation, the payment server 102 may access the information stored in database 106 with appropriate database software (e.g., MySQL) or a custom database software. In further implementations, payment server 102 can be a web-based server or a cloud server, running appropriate software, such as Apache, and or other types of scripting software (e.g., Ruby, Perl and the like) that allow the payment server 102 to seamlessly communicate information with payee telecommunications device 100.

It is to be appreciated that the software and hardware components discussed above in connection to payee telecommunications device 100 and payment server 102 are not by any means exhaustive. Accordingly, additional components necessary for the operation of payee telecommunications device 100 and payment server 102 (e.g., not described herein for brevity) are within the spirit and the scope of this disclosure. For example, payment server 102 may be equipped with speech recognition software and appropriate hardware to facilitate audio communication when such audio communication is desirable.

According to some embodiments, payment server 102 may be communicatively coupled to optional third-party sources 108 for funding and/or credit verification. These third-party sources 108 may include various creditors (e.g., banks, credit card companies, and/or other traditional or non-traditional sources of funds), which can be used for the financial transactions described herein. According to some embodiments, when the organization that runs the payment server 102 is equipped with adequate financial resources, the optional third-party sources 108 may not be used, or alternatively may be replaced with credit rating agencies and the like.

The third leg of the system is the payer (e.g., the customer; not shown), who can interact with the payment server 102 and payee telecommunications device 100 via a payer telecommunications device 110. By way of example and not limitation, payer telecommunications device 110 can be a mobile phone, a smartphone, a smart watch, a tablet, laptop computer, desktop computer, or any other computerized device capable of storing a unique identification token, and/or equipped with a biometric sensor, such as a fingerprint sensor, a face sensor, and the like. For example purposes, payer telecommunications device 110 will be described in the context of a mobile phone (e.g., a smart phone) capable of running a payment application and sending and receiving text messages from/to the payment server 102. Additionally, payer telecommunication device 110 may also be capable of sending messages using Short Message Service (SMS). According to some embodiments, the payer telecommunications device 110 may be capable of at least establishing a network connection (e.g., via network 104) with payment server 102 and often, but not necessarily always, with the payee telecommunications device 100, as indicated by respective bidirectional communication link 116 and communication link 112 in FIG. 1A.

In some embodiments, the method described herein is a computer-implemented method running on payment server 102. Accordingly, all (or at least the majority) of the operations described herein may be implemented by payment server 102. According to some embodiments, the payee telecommunications device 100 and the payer telecommunications device 110 may simply interact with software running on payment server 102. In other embodiments, the method described herein can be a computer-implemented method performed in-part through the use of custom software applications running on the payer telecommunications device 110 and/or the payee telecommunications device 100. In yet another embodiment, when the payment server 102 is a web-based or cloud-based server, payment server 102 may serve web pages intended to run under the control of the processor(s) in the payee telecommunications device 100 and payer telecommunications device 110—which may perform various functions, such as display TIDs, store information, provide data inputs/outputs, control biometric sensors, and the like.

It is to be appreciated that communication between the payee telecommunications device 100 and the payer telecommunications device 110 may not be machine-based or use network 104, although they may For example, communication between payee telecommunications device 100 and payer telecommunications device 110 may be established via electromagnetic signals (e.g., wired or wireless), audio signal (e.g., via verbal communication), written communication, pointing, sign language, and/or any other type of signal or communication that establishes an exchange of information between the payer and payee. For example, when the payer and payee are face-to-face at a check-out counter, communication link 112 can represent verbal or written communication between a customer and a clerk. In this case, the communication (e.g., the exchange of a transaction ID) between the customer using payer telecommunications device 110 and the merchant using the payee telecommunications device 100 can be verbal or written. Thus, communication link 112 may represent a simple verbal statement: “The transaction ID is 352431 for your purchase”, and thus communication link 112 does not have to be over network 104, although it may be.

Alternatively, the payee telecommunications device 100 may be a customized device, such as a modified terminal or cash register, that displays the TID directly to the customer so that the customer can enter the TID in his/her payer telecommunications device 110. By contrast, communications to and from the payment server 102 can be established through network 104 for both the payee telecommunications device 100 and the payer telecommunications device 110. Accordingly, communication link 116 and communication link 114 represent communications via network 104.

According to some embodiments, the method and system described herein utilize a transient TID for making payments when a payment server 102, which is communicatively coupled to network 104, interacts with at least one payer telecommunications device 110 and a payee telecommunications device 100. As discussed above, the payment server 102 may optionally be communicatively coupled to at least one payment source, such as third-party sources 108 or an alternative source of funds.

According to some embodiments, and prior to initiating any transactions, the payer is required by the payment server 102 to establish a link between his/her payer telecommunications device 110 and a source of funds, such as one or more payer credit cards, a bank account, or the like.

According to some embodiments, FIG. 1B depicts a variation of the system shown in FIG. 1A in which the payer may use an alternate payer telecommunications device 120, different from the payer telecommunications device 110, to receive information directly from the payee telecommunications device 100. For instance, in FIG. 1B, the payer may communicate with the merchant over a telephone landline or via a web-browser on the alternate payer telecommunications device 120, receive on the alternate payer telecommunications device 120 a TID from the payee telecommunications device 100 (as indicated via communication link 112), and relay the received TID to the payer telecommunications device 110, as indicated by communication link 122. Subsequently, the TID may be transmitted from the payer telecommunications device 110 to the payment server 102 via the communication link 116. In the example of FIG. 1B, the payer telecommunications device 110 remains the main authentication device via which payment server 102 can authorize payments made to the payee telecommunications device 100.

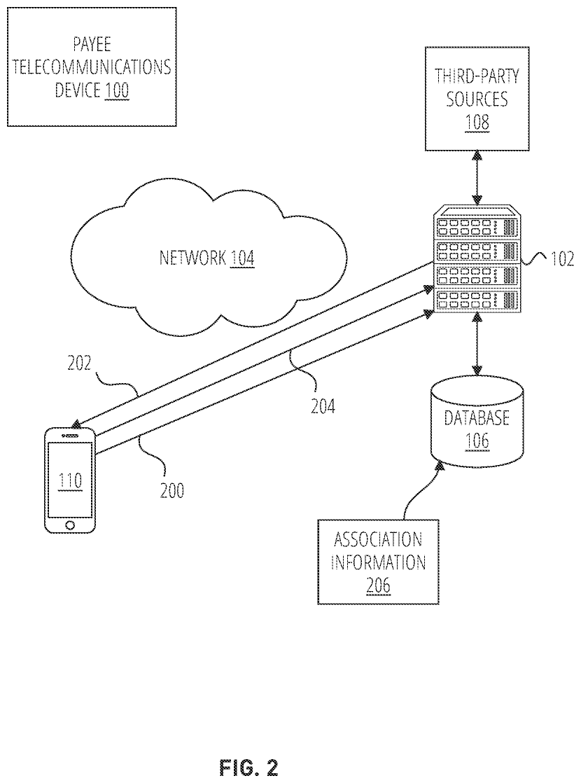

According to some embodiments, FIG. 2 schematically shows the process for linking a payer's financial information, such as a credit card or a bank account, to his/her payer telecommunications device 110 using the system of FIG. 1A. As discussed above, and for example purposes only, payer telecommunications device 110 is described in the context of a smart phone. However, other suitable devices may be used without departing from the spirit and the scope of the disclosure. For example, a laptop computer, a desktop computer, a tablet, a smart watch, or any suitable device capable of connecting and communicating with payment server 102 via network 104 may be used. By way of example and not limitation, the device ID of the payer telecommunications device 110 (e.g., its serial number or any other unique device identifier) may be combined with the payer's mobile phone number to form a unique identification number that allows the payment server 102 to uniquely identify and authenticate the payer telecommunications device 110. However, this is not limiting, and the device ID may be paired with the payer's biometric signatures (e.g., fingerprints, face ID, etc.) or a password to create the unique identification number. It is noted that the authentication or verification process described above does not rely on any kind of third party verification documentation or information, such as a photo ID, a social security number, or an external party, etc. Therefore, the payer can register his/her payer telecommunications device 110 with payment server 102 by merely providing his/her mobile phone number, which serves as the only means of identity verification. Subsequently, the payment server 102 may use this information (e.g., the device ID and a phone number, a password, a biometric signature, or any combination thereof) to establish a link between the payer's payer telecommunications device 110 and the payer's financial account information; thus, uniquely associating the payer and his/her payee telecommunications device with the payment server 102. This process also establishes the validity of the association between the payer's phone number and the payer telecommunications device 110.

To establish this link, the payer may initially provide to the payment server 102 (e.g., via the payer telecommunications device 110) at least the device ID from the payer telecommunications device 110, a phone number associated with the payer telecommunications device 110, and his/her financial account information (e.g., a credit card number, a bank account, etc.) that can be used for future transaction. In some implementations, the payment server 102 may acquire the device ID without intervention form the payer. For example, the payer may only need to provide his/her mobile phone number and his/her financial information. In some implementations, the payer may authorize the payment server 102 to retrieve the device ID information and other information (e.g., phone number or biometric information) automatically with a pre-authorization from the payer. Upon receiving this information, the payment server 102 may create a unique identification number associated with payer telecommunications device 110 (and the payer), and store it in the database 106. It is to be understood that database 106 can be a local (e.g., internal) storage or external storage to the payment server 102. In some embodiments, the stored unique identification number may be encrypted when stored in database 106 for security reasons.

By way of example and not limitation, when the payer is using a mobile phone or smartphone, the payer can either use an application running on the smartphone, text messaging (e.g., SMS messages), or even voice messaging (using caller ID) to transmit related information to the payment server 102. For instance, the payer may transmit the information “I wish to associate my credit card #123456 with this mobile phone,” as indicated by communication link 200 in FIG. 2.

Once the information is received by the payment server 102, the payment server 102 may respond with a confirmation request to proceed as shown by communication link 202. For instance, the confirmation request may read “Confirming that you wish to link credit card #123456789 with your mobile phone number (XXX) XXX-5309.” When the payment server 102 is optionally connected to third-party sources 108, the payment server 102 may confirm with the third-party sources 108 that funds associated with the financial information provided by the payer are present and available for use. Subsequently, the payer may send a confirmation to the payment server 102 via the payer telecommunications device 110 that he/she wishes to proceed with the registration, as indicated by communication link 204. Upon receiving confirmation from the payer, the payment server 102 may generate the unique identification number, associate the unique identification number to the payer telecommunications device 110 (e.g., a payer device ID) and to the financial information as provided by the payer, and store this information to database 106 as association information 206. For example, the association information 206 may include information such as “Payer device ID associated with Payer credit card 123456.”

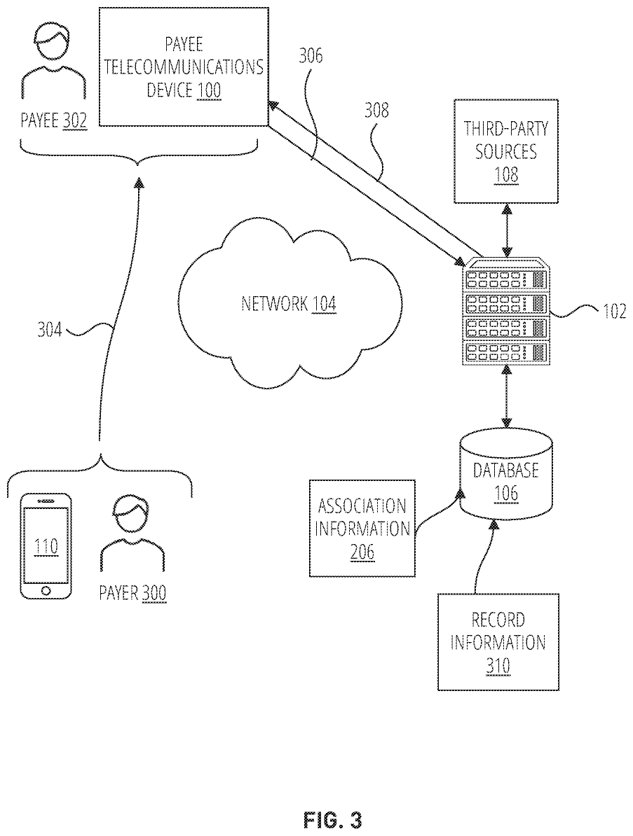

Reference is now made to FIG. 3 which schematically describes the interactions between a payer 300 and a payee 302 (via their respective devices, payer telecommunications device 110 and payee telecommunications device 100) with the payment server 102 prior to a financial transaction involving an item for purchase, according to some embodiments. It is noted that the item for purchase may encompass physical products, one or more services, or any combination thereof. According to some embodiments, the agreed upon price for the product may have been determined between the payer 300 and the payee 302 at an earlier time—i.e., before any financial transaction is initiated between the parties.

In some embodiments, an agreement to purchase a product may be communicated from the payer 300 to the payee 302 without the use of payer telecommunications device 110 or the payee telecommunications device 100. For example, the payer 300 may directly communicate with the payee 302 when they are both physically present at the same location (e.g., at a counter in a store), and accept the payee's bid for a $5.98 widget by a direct verbal confirmation, such as “I wish to purchase your widget for $5.98 and pay by TID,” as indicated by communication link 304. Alternatively and/or additionally, the payer 300 may communicate his/her intention to purchase the product (e.g., the $5.98 widget) by other means, such as by clicking on an item on the payee's website via payer telecommunications device 110 or another device, such as the alternate payer telecommunications device 120 shown in FIG. 1B, as indicated by the communication link 304. Thus, communication link 304 may represent a direct communication between the payer 300 and the payee 302, an indirect communication between the payer 300 and the payee 302 (e.g., between the payer telecommunications device 110 and the payee telecommunications device 100), or any combination thereof.

According to some embodiments, once the payer 300 (e.g., the customer) indicates his/her intention to purchase the widget by TID, the payee 302 can contact the payment server 102 using the payee telecommunications device 100 to request a TID for the widget amount (e.g., “Request TID for $5.98”), as indicated by communication link 306 in FIG. 3. In some embodiments, and along with the request, the payee telecommunications device 100 may submit an identifier that uniquely identifies the payee telecommunications device 100, such as a merchant ID and/or second geographical location data, such as the time of the transaction. Upon receiving the request, the payment server 102 can generate and transmit the TID to the payee telecommunications device 100, as indicated by communication link 308. The payment server 102 may also capture the above exchange of information with the payee (e.g., “Transaction ID 352431 for $5.98 sent to merchant ID communications device”) as record information 310, and subsequently store the record information 310 in database 106.

According to some embodiments, the payment server 102 can generate a timestamp that corresponds to the time when the TID is first generated, and use the generated timestamp as a reference to further define a duration period for which the TID can be active (e.g., for 1 min, 5 min, 10 min, 1 hour, 1 day, etc.). This duration period is referred to herein as the “validity window.” In some embodiments, the timestamp can be based on a commonly accepted universal time reference—also used and referenced by the participating devices, such as the payment server 102, the payee telecommunications device 100, and the payer telecommunications device 110. For instance, once the payment server 102 receives the TID request from the payee 302, and the payment server 102 generates the TID and its corresponding timestamp, the payment server 102 may generate a “TID/payment amount/validity window” string (e.g., “TID: 352431 for $5.98 valid for 5 minutes”) and communicate this information back to the payee 302 via communication link 308. In some implementations, instead of defining a duration period or a validity window for the TID, payment server 102 may generate an expiration date/time for the TID that indicates when the TID will expire based on its timestamp. According to some embodiments, the combination of the TID along with its corresponding timestamp, validity window, or expiration time/date can uniquely define the financial transaction.

In some embodiments, the payee 302, along with the TID request, may indicate to the payment server 102 a desired validity window for the issued TID. For example, the TID request, as indicated by communication link 306 in FIG. 3, may include information such as “Request TID for $5.98 with a validity window of 1 hour.” Accordingly, the validity window may be requested by the payee 302 and set by the payment server 102.

In some implementations, the TID can be a transient TID with a short validity window (e.g., a validity window of about one hour, 30 minutes, 10 minutes, etc.). This means, that the number of unique transactions that the payment server 102 can support within the short validity window may be substantially reduced. Further, the length of the TID that allows the payment server 102 to distinguish each and every active transaction within the short validity window may be relatively short. According to some embodiments, the length of the TID may be appropriately selected (e.g., by the payment server 102) so that the TID can uniquely identify each and every active transactions within a given validity window while reducing the risk for the payer to incorrectly enter a TID that would result in a valid match. For instance, 10 (or less) alphanumeric characters, which may correspond to one million active transaction, can reduce the probability of a misentered TID triggering a valid match to less than one in a billion. In some embodiments, a transient TID may be convenient or preferred when it is communicated verbally between parties (e.g., between the payer 300 and the payee 302), or when the TID is used in transactions where transaction security is paramount.

In some embodiments, the TID is intended to be used only once with a provided merchant ID and payment amount combination and within its defined validity window. Once the validity window expires, the TID may only be used with a different merchant ID and payment amount. In other words, a TID may appear in multiple record information 310 with each record information 310 corresponding to a unique transaction (e.g., purchase). The duration of the validity window may be determined as desired by the payment server 102, or in some embodiments, by the payee 302 when a TID is first requested from the payment server 102 by the payee 302. For example, the TID can be set to be valid for weeks, days, hours, or even minutes (e.g., 1 minute, 5 minutes, 1 hour, 1 day, 1 week and so on). In a some embodiments, the transient TID may be generated in a manner (e.g., randomly selected) that does not provide any hints to the actual payer's financial account (e.g., credit cards) and personal information. This is evident by the fact that the TID is generated by payment server 102 even before the payment server 102 knows who the actual payer is.

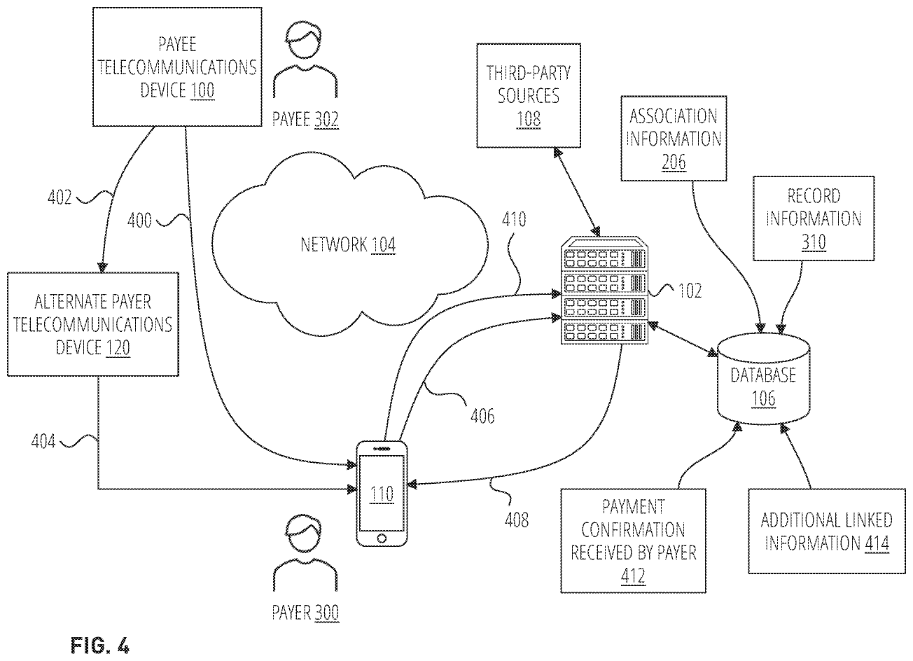

Reference is now made to FIG. 4, which schematically describes a method for making electronic payments with a transient TID using the systems and processes described in FIGS. 1A-1B, 2, and 3. According to some embodiments, once the payee 302 receives the TID from the payment server 102 as discussed in FIG. 3, he/she can communicate the TID to the payer 300. In some examples, communication of the TID from the payee 302 to the payer 300 may occur either: (i) through a direct electronic communication between the payee telecommunications device 100 and the payer telecommunications device 110 (e.g., through communication link 400); or (ii) by having the payee 302 read the TID to the payer 300 (e.g., via verbal communication) so that the payer 300 can enter the TID to the payer telecommunications device 110; or (iii) by having the payee 302 displaying the TID on the payee telecommunications device 100 for the payer 300 to visually check and enter the TID in the payer telecommunications device 110; or (iv) through an indirect communication between the payee telecommunications device 100 and the payer telecommunications device 110 through the alternate payer telecommunications device 120 (e.g., via communication link 402 and communication link 404).

According to some embodiments, once the payer 300 receives the TID from the payee 302 (through any of the methods (i)-(iv) described above), the payer 300 can transmit the TID to the payment server 102 via the payer telecommunications device 110, as indicated by communication link 406. When the payer 300 transmits the TID to payment server 102, the time of transmission (which may correspond to, or be substantially close to, the time of the transaction, as provided by the payee 302 to the payment server 102 during the TID request process discussed above) can be used as an attribute by the payment server 102 to further associate the payer 300 with the financial transaction in progress.

In some embodiments, the payment server 102, upon receiving the TID from payer telecommunications device 110, can request confirmation from the payer telecommunications device 110 that payer 300 indeed wishes to pay the TID for the agreed upon amount, as indicated by communication link 408. For example, the request may look like “Please confirm: You wish to Pay Transaction ID 352431 for $5.98?” In response, the payer 300 can confirm the transaction by sending a confirmation via his/her payer telecommunications device 110 to the payment server 102, as indicated by communication link 410. For example, the confirmation may look like “I am authorizing payment of Transaction ID 352431.” In some embodiments, payment server 102 may store in database 106 the confirmation information received by payer telecommunications device 110 as payment confirmation received by payer 412. For example, payment confirmation received by payer 412 may include information such as “Payer ID requests payment of transaction ID 352431—confirmed to Payer device ID.” The payment server 102 may also store information related to the link established between the TID and the merchant ID, the device ID of the payer telecommunications device 110, the transaction amount, and the payer's payment method (e.g., the payer's credit card or account number) as additional linked information 414. For example, the additional linked information 414 may include information such as “Transaction ID 352431 linked to merchant ID, Payer device ID, transaction amount of $5.98, and Payer credit card 123456.” At this point, the payment server 102 has sufficient information to complete the transaction. In some embodiments, the stored information in database 106 can be encrypted for security reasons and organized in any suitable format.

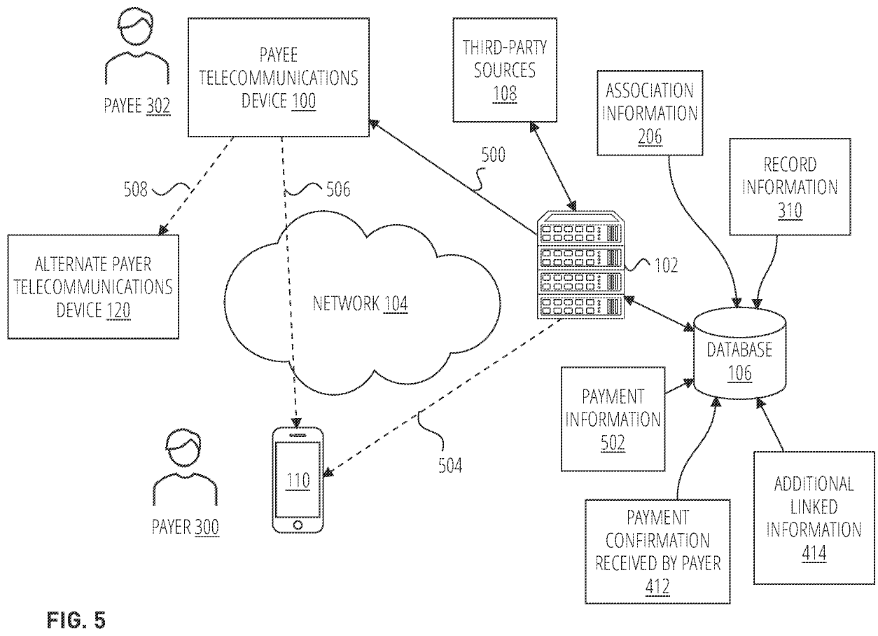

Reference is now made to FIG. 5, which schematically describes a method for making electronic payments with TID codes, and more specifically, the process of authorizing the transaction and transfer of funds to payee 302, according to some embodiments. The payment server 102, optionally in conjunction with one or more third-party sources 108, can authorize the transaction and initiate the process of transferring payer funds to the payee 302 as indicated by communication link 500. Concurrently with the payment, or immediately after the payment is processed, the payment server 102 can record the payment in database 106 as payment information 502 (e.g., “Paid $5.98 to Merchant ID using credit card 123456”). In some embodiments, database 106 will also log the time of the transaction and the TID associated with the transaction. In some embodiments, payment server 102 may optionally generate and send a confirmation message to payer telecommunications device 110 of payer 300, as indicated by communication link 504. For example, the confirmation message may read “$5.98 paid to merchant ID on credit card #12345.” In some implementations, the payee 302 may send, via the payee telecommunications device 100, additional confirmation messages to payer 300 either directly to the payer telecommunications device 110 or to alternate payer telecommunications device 120, as indicated by respective communication links 506 and 508.

According to some embodiments, once the transaction is complete, and/or the validity window (e.g., 1 minute, 1 hour, 1 day, 1 week, 1 month) for which the TID is valid has expired, the TID used for the specific transaction (e.g., with the specific merchant ID and transaction amount) is invalidated and can no longer be honored by the payment server 102.

In some embodiments, the payment server 102 can persistently store the transaction information in database 106 to comply with financial regulations and statutes. The persistently stored information may include at least the TID and the time stamp associated with the transaction since the TID and the timestamp associated with the transaction uniquely identify the financial transaction between the payer 300 and payee 302. In further embodiments, the persistent stored information in database 106 may include at least identification information pertaining to the payee 302 (e.g., the merchant ID), the identification information pertaining to the payer 300 (e.g., the device ID from payer telecommunications device 110), the time of the transaction, the payment or transaction amount, and the transient TID so that the financial transaction can be later retrieved and audited by authorized individuals and agencies as necessary.

### Geographically Bounded Implementations Using Short TIDs

In some implementations, location data may be collected to enable the use of shorter TID codes—e.g., TID codes with fewer alphanumeric or numeric characters—which can improve convenience under certain circumstances, such as when there is face-to-face communication between the payer and the payee, or when the payer uses an alternate payer telecommunications device 120 from which he/she needs to manually enter the TID to the payer telecommunications device 110. In some embodiments, location data may include location coordinates obtained from global positioning system (GPS)-enabled devices such as the payee telecommunications device 100 and/or the payer telecommunications device 110. Alternatively and/or additionally, location data may be obtained from Wi-Fi access points, wireless cell towers, Bluetooth signals from nearby devices whose location is known, Bluetooth interactions between devices in general, and the like. In some embodiments, the payee telecommunications device 100 and the payer telecommunications device 110 are equipped with components (e.g., hardware and software) that allow these devices to determine whether payee 302 and payer 300 are in close geographical proximity—e.g., within about 1 foot, about 2 feet, about 5 feet, about 10 feet, about 20 feet, about 50 feet, about 100 feet, about 300 feet, or more from each other.

According to some embodiments, and in situations where both the payee and payer are in relatively close geographic proximity or vicinity to each other, a short transient TID may allow the payment server 102 to uniquely bind the payee 302 and payer 300 with a given transaction. In some implementations, the payment server 102 and/or the payer 300 may determine how close in terms of geographical position the payee telecommunications device 100 and the payer telecommunications device 110 need to be so that a (transient) TID with a fewer number of characters can be used for a transaction between the parties. In some implementations, a default distance that is shorter than about 300 feet may be used. However, this is not limiting, and shorter or greater distances (e.g., greater distances within about 1 mile, or shorter distances within about 10 feet, 3 feet, and so on) may also be specified. According to some embodiments, there is no requirement that the two telecommunications devices (e.g., the payer telecommunications device 110 and the payee telecommunications device 100 are brought into direct physical contact, although shorter distance limits (e.g., shorter than 2 feet or 1 foot) may also be specified by the payment server 102 or payer 300, if desired.

In some implementations, the location data described herein correspond to the one or more attributes, which collectively with the TID uniquely identify the financial transaction between payee 302 and payer 300. Additionally, the location data belong to the type of attributes that can be offered or provided by both parties (the payee 302 and the payer 300), as opposed to types of attributes that are offered or provided by a single party (e.g., either the payee 302 or the payer 300). Advantageously, because the location of the payee 302 and payer 300 are provided via registered and trusted devices (i.e., payer telecommunications device 110 and payee telecommunications device 100), the payment server 102 can ensure that the location data provided is reliable. In other words, the payment server 102 does not need to verify that the location data provided are accurate by using a third party verification method (e.g., by collecting location information for the telecommunications device from networks or other sources)—which can substantially improve the robustness of the system, simplify the verification process, and reduce the system's response time.

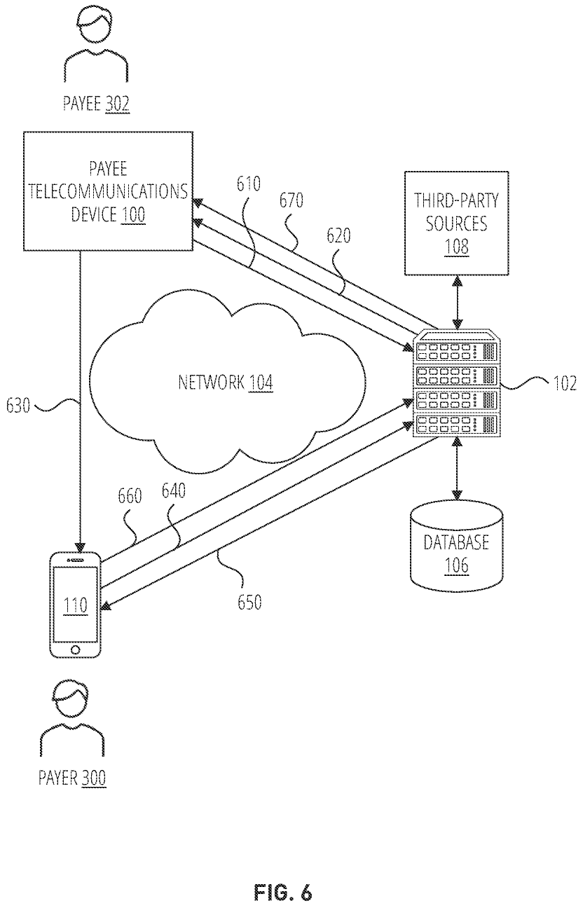

Reference is now made to FIG. 6 which schematically describes a method for making electronic payments with short TID codes using geographical location data. It is noted that in FIG. 6, the TID will be described in the context of a transient TID (e.g., a temporary TID), and thus, the terms “TID” and “transient TID” maybe used interchangeably throughout this description. Additionally, geographical location data will be described in the context of location coordinates provide by a GPS-enabled device, such as the payee telecommunications device 100 and the payer telecommunications device 110. However, as discussed above, other methods may be used to provide the (geographical) location data (e.g., Wi-Fi access points, wireless cell towers, Bluetooth signals from devices whose location is known, Bluetooth interaction between devices, etc.), all of which can be provided via the payer telecommunications device 110 and payee telecommunications device 100. These other methods are within the spirit and the scope of the disclosure.

According to some embodiments, the process begins with the payee 302 requesting, via his/her payee telecommunications device 100, a transient TID from payment server 102. Concurrently with the request of the transient TID, the payee telecommunications device 100 transmits its GPS coordinates to the payment server 102. This information exchange between the payee telecommunications device 100 and payment server 102 is schematically shown by communication link 610. In some embodiments, the payee telecommunications device 100 is pre-configured to automatically provide its location information to the payment server 102 when a TID is requested. In some embodiments, the payee telecommunications device 100 may be previously registered with payment server 102 and configured so that when a TID is requested by payee 302, it transmits its location information to payment server 102.

In some embodiments, the payee 302 may send a second attribute (e.g., in addition to the location data) concurrently with the TID request to payment server 102. For example, as discussed in the Time Bounded Implementations section above, the payee 302 may send a request for the issued TID to be active for a certain duration period. Thus, in some implementations, the payee 302 may send a request for a TID and provide two attributes, its location data and the desired duration period for the issued TID.

In response to receiving the TID request, the location data, and the desired TID duration period from payee telecommunications device 100 (e.g., the one or more attributes), the payment server 102 can transmit a unique transient TID to the payee telecommunications device 100, as indicated by communication link 620. Subsequently, the payee telecommunications device 100 can transmit the received transient TID to payer telecommunications device 110, as indicated by communication link 630. According to some embodiments, and as discussed above in reference to FIG. 4, communication of the TID from the payee 302 to the payer 300 may occur either: (i) through a direct electronic communication between the payee telecommunications device 100 and the payer telecommunications device 110; or (ii) by having the payee 302 read the transaction ID to the payer 300 (e.g., via verbal communication) so that the payer 300 can enter the transaction ID to the payer telecommunications device 110; or (iii) by having the payee 302 displaying the transaction ID on the payee telecommunications device 100 for the payer 300 to visually check and enter the transaction ID in the payer telecommunications device 110; or (iv) through an indirect communication between the payee telecommunications device 100 and the payer telecommunications device 110 through the alternate payer telecommunications device 120 (not shown in FIG. 6, but shown in FIG. 4). In other words, communication link 630 shown in FIG. 6 encompasses all the communication methods discussed in FIG. 4 (i.e., the communication methods (i)-(iv)). In response, the payer telecommunications device 110 can transmit the received transient TID and its location data (e.g., its GPS coordinates) to the payment server 102, as indicated by communication link 640. In some implementations, payer telecommunications device 110, like payee telecommunications device 100, can be pre-configured to provide its location data to the payment server 102 automatically. Alternatively, payment server 102 may request pre-authorization from the payer 300 to share his/her location data when transmitting the TID through the payer telecommunications device 110.

According to some embodiments, the payment server 102 compares the GPS coordinates and transient TID received from the payee telecommunications device 100 to those received from the payer telecommunications device 110, and if there is a match, the payment server 102 transmits the invoice information to the payer telecommunications device 110 via network 104, as indicated by communication link 650. The payer 300 has the option to approve the invoice and transmit the approval along with a payment information to the payment server 102, as indicated by communication link 660. Upon receiving the approval and payment information from the payer telecommunications device 110, the payment server 102 transmits a transaction success notice or message to the payee telecommunications device 100 and credits the invoice amount to the payee's financial institute, as indicated by communication link 670. In some embodiments, the payer 300 may only need to approve the invoice without the need to transmit any payment information back to the payment server 102. For example, such payment information may have been established and stored in the payment server 102 at a prior step—e.g., during the initial registration of the payer telecommunications device 110.

According to some embodiments, the operations described above (e.g., the operations represented by communication links 610-670) demonstrate how payment system generated, and payee provided, transient, short TID codes may be used for carrying out payer to payee payments for transactions based on geographical location criteria. In the method described in connection to FIG. 6, the length of the transient TID can be further reduced if the geographic region, for which the generated transient TID is issued, is limited to a smaller area. In other words, the smaller the geographical region in which the generated transient transaction ID is valid, the shorter the length of the TID. For example, the generated transient TID may be valid and unique only for those payer(s) whose telecommunication device(s), and hence the location of the payer(s) themselves, is/are within the limited region around the payee's telecommunication device, and hence the payee's geographic location.

By way of example and not limitation, the valid geographical region/area around the payee telecommunications device 100 can be limited by having the payment server 102 to require that the GPS coordinates from the payee telecommunications device 100 and payer telecommunications device 110 are within a threshold distance range from each other. It is noted that this payer-payee distance range thresholds may also be established through other electronic means. For example, the payment server 102 may require that payee telecommunications device 100 and payer telecommunications device 110 are connected to the same unique Wi-Fi router, or that both devices are within Bluetooth range from one another, or that both devices are within the same cell phone tower triangulation range, and so on.

It is further noted that the process described in FIG. 6 is simplified and focused on key aspects of the method. Therefore, some steps or operations may be omitted merely for brevity. For example, it is to be understood that information and data collected by payment server 102 can be stored in database 106 according to the description provided for FIGS. 1-5.

According to some embodiments, any or all of the above variations with respect to which party controls the expiration date/time of the TID (e.g., the payee, the payer(s), or the payment server 102) can be implemented in any of the examples provided herein.

### Group Identification Implementations Using Short TIDs

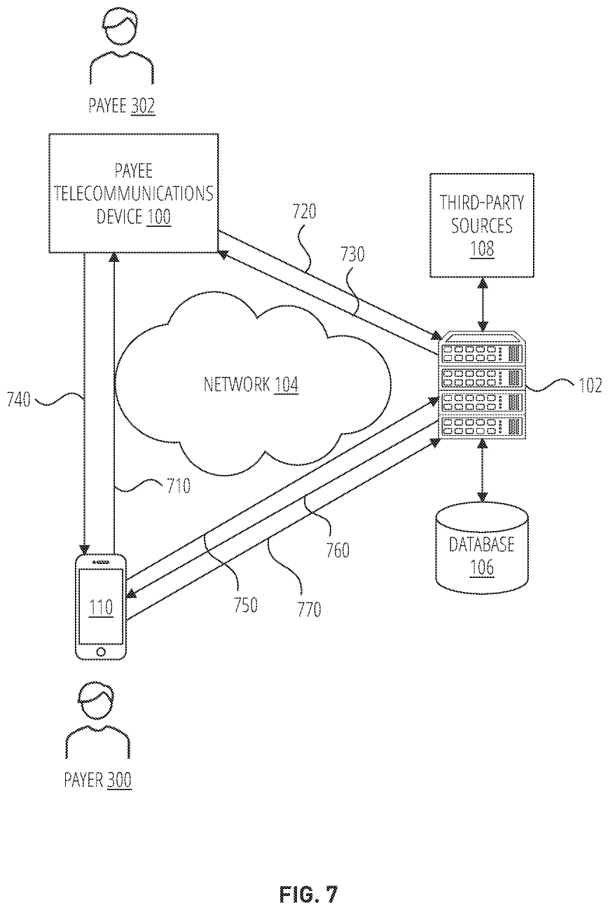

Reference is now made to FIG. 7 which schematically represents another method for making electronic payments with short, transient TID codes. Contrary to previous examples where the payment server 102 generates transient TIDs that are unique only amongst a group of payers, in this example, some or all of the potential pool of payers may be divided into corresponding groups with each group being identified by a Group Identification number or Group ID (there after “GID”). In some implementations, the GID is pre-assigned by the payment server for each payer device (e.g., for each payer telecommunications device 110) within the group. Various methods can be used to generate a GID. The GID could, for example, be created by using the last four digits (or any four sequential digits) of the mobile phone number associated with the payer's device. That is, if the mobile phone number is (XXX) XXX-5309, the GID could be the last four digits (i.e., 5309). The GID can also be randomly assigned based on a payee's biometric characteristic, a CAPTCHA response, and the like. However, the intent here is that the GID can be effortlessly recalled by the payee.

In some embodiments, the GID can be used as an attribute in the process described herein, which would allow the TID to be shorter than what it would otherwise be. In the example of FIG. 7, the payer 300 provides his/her assigned GID to the payee 302, as indicated by communication link 710. This means that the method described in FIG. 7 is a payer-initiated transaction, as opposed to a payee-initiated transaction discussed in FIG. 6. In response, the payee 302 can send the payer's GID to the payment server 102 and request the payment server 102 to provide a short, transient, and unique TID, as indicated by communication link 720. Subsequently, the payment server 102 transmits the TID to payee 302, as indicated by communication link 730. Once the payee 302 receives the TID in his/her payee telecommunications device 100, he/she transmits the TID to the payer 300 (e.g., to the payer's payer telecommunications device 110), as indicated by communication link 740. It is to be understood, that communication link 740, like communication link 630 in FIG. 6, encompasses a variety of communication methods between the payee 302 and payer 300. Additionally, the same is true for communication link 710, as would be understood by a person skilled in that art. The payer 300 can then transmit the TID to the payment server 102 along with his/her payer GID to be used in conjunction with the transmitted TID, as indicated by communication link 750. Once the payment server 102 matches the TID as originally provided by the payment server 102 to the TID as received by the payer 300, the payment server 102 transmits the invoice to payer telecommunications device 110 of payer 300, as indicated by communication link 760. Assuming that the payer 300 agrees to pay the invoice, the payer 300 can then transmit an approval of the invoice and may also provide a payment method to the payment server 102, as indicated by communication link 770.

According to some embodiments, many aspects of the communication between the payer 300, the payee 302, and the payment server 102 can be similar to the ones described above in reference to FIGS. 3-6. However, in this example, there is the notable addition of the GID attribute into the process, and a change in the transaction initiation sequence, which starts with the payer 300 instead of the payee 302. In some embodiments, when the payee 302 sends the GID and the request for a TID to payment server 102 as represented by communication link 720, the payee 302 may also provide an additional attribute, such as the desired duration or validity period for the issued TID. Therefore, in this example, two attributes may be provided; the GID (originating from the payer 300) and the duration period for the TID (originating from the payee 302).

According to some embodiments, some of the information used for the generation of a GID can be one or more digits of the phone number corresponding to the payer telecommunications device 110, and/or some of the characters from a user name (if any) used by the payer to bind his/her payer telecommunications device 110 to the payment server 102. In alternative embodiments, any suitable information used by the payer to bind his/her payer telecommunications device 110 to the payment server 102 may be used as part of the GID (e.g., the payer's favorite color, food, a pet name, etc.). In situations where part of the payer's phone number is used, the more numbers are used for the GID, the smaller the payment group size can get. For example, if the entire phone number of the payer is used as the GID, then the group size would degenerate to “1”—e.g., a single-member group. In the context of a single-member group, the GID becomes a globally unique GID (GUGID) that uniquely characterizes the single member in the group. Thus, when there is only a single candidate payer in the system and there is only one active transaction, the payment server 102 can effectively provide a very short or even a NULL transient TID. In this context, a NULL transient TID can be a simple indication from the payment server 102 to the payee 302 that no TID is required for the specific transaction, and that the financial transaction may continue without the issuance of a TID. Thus, when the payee 302 receives that no TID is required, the payee 302 can relay this information to the payer 300 (e.g., via communication link 740), who then transmits the GUGID to the payment server 102 (e.g., via communication link 750) without the need to provide a TID. In some embodiments, a NULL transient transaction ID can still bind a specific transaction to a specific payee and payer.

In some embodiments, the payment server 102 can assign a GID (or in some embodiments, a GUGID) to each payer telecommunications device. For example, the payment server 102 can assign (e.g., issue) a GID to the payer telecommunications device 110 when the payer first registers his/her payer telecommunications device with the payment server 102. This payment server provided GID can, for example, be established when a connection or link between the payment server 102 and the payer telecommunications device 110 is initially established. The payment server provided GID may then be used to identify the payer telecommunications device 110 whenever the payer telecommunications device 110 communicates with the payment server 102. For example, the payee 302 can then present to the payment server 102 the payers' GID, along with the request for the transient TID; and in response, the payment server 102 can generate a unique transient TID (or a NULL TID if the GID corresponds to a GUGID, whichever the case may be) for the group of payers identified by the supplied GID.

Because the payment server 102 only needs to pair up a candidate payer with a comparatively small group or pool of payers having the same GID, rather than with the entire universe of potential payers, the length of the transient TID can also be shorter than what it would otherwise be. This shorter in length and unique TID may then be passed to the payer by the payee. The payer can then present it to the payment server 102 as before. This can be advantageous because it substantially shortens the length of the TID used, which simplifies the transaction process.

In some implementations, the system may operate either with or without the use of an GID or a GUGID. If a GID is not used, the system may default to a time bounded implementation or a geographically bounded implementation as described above. Switching between methods that use or do not use a GID (or a GUGID) can be done in various ways depending on whether a shorter TID or a NULL TID is desired. In some implementations, the payer or the payment server 102 may explicitly specify that GID methods are being used. Alternatively or additionally, the use of GID (or a GUGID) may be set as the default option of operation.

Alternative schemes may also be used to reduce the length of the transient TID. For example, any additional type of information may be used as a GID proxy to enable shorter, and thus more user friendly, transient TID codes. This information can, for example, include the payer's favorite color, favorite food, type of figurine on the payer's counter, first few digits of the payee's address, and the like. This additional information can be used as supplemental information that can reduce the length of the transient TID or even eliminated the need for a TID (e.g., in the case of a NULL TID).

In some embodiments, the GID-based method may be combined with other methods described herein to eliminate the need for a long or complex TID or to eliminate the need for a TID altogether (e.g., require a NULL TID). For instance, the payer 300 may request from the payment server 102 to issue (e.g., generate) and provide a GID that is unique to a geofence location as defined by GPS coordinates or other means (e.g., by cell tower triangulation, Wi-Fi signals, etc.). In some implementations, the location data (e.g., from a GPS or other systems) and GID-based methods may be combined to create, for a short period of time (e.g., on a transient basis), a group that defines a single member. It is to be appreciated that the payer 300 can request from the payment server 102 to provide a GUGID for a specific geofence location on a need basis. When a group within a geofence location contains a single member, a transient TID may not be necessary to identify this one member, as discussed above. That is the TID in this instance can be a NULL TID. For example, the system may optionally be configured to remove the requirement for the payer or the payee to use a transient TID when there is only one payer present within the geofence location that includes both the payer and the payee. Thus, the payment server 102 can be configured to indicate to the payee 302 to provide a NULL transient TID to the payer 300. This NULL transient transaction ID can be a simple indication that that payment server 102 has acknowledged that it has received the transaction information, and now the payer can start the payment process (i.e., request the payment server 102 to present the transaction information), without having to make any explicit transient TID entry.

In yet another embodiment, the payer 300, instead of requesting a GID, may request the payment server 102 to provide a GUGID (e.g., a GID that uniquely identifies the payer and his/her telecommunications device), such as the payer's entire phone number or the payer's partial phone number combined with another piece of information, that can be provided to the payee 302. Once a GUGID is issued (e.g., generated), the transaction may proceed as if the payer 300 had requested a generic or “non-globally unique” GID, but without the need for a TID. In this context, the payer's phone number can correspond to a payer associated ID (thereafter “PAID”), which when combined with a another piece of information (e.g., a payment server provided ID or PSPID) corresponds to a GUGID that eliminates the need for a TID.

Registration of the payer's payer telecommunications device, such as payer telecommunications device 110, may occur in several different ways. For example, one approach is to complete the registration process via a web interface running on the payment server 102 that enables the payer to register his/her device (e.g., the payer telecommunications device 110) with the payment server 102. For example, as part of the registration process, the payer with a payer telecommunications device, which has an associated mobile phone number, can provide the associated mobile phone number to the payment server 102 as the PAID. Subsequently, the payment server 102 can be configured to verify the mobile phone number (e.g., the PAID) by sending, for example, an SMS message, containing an alphanumeric code (e.g., a verification alphanumeric code), to the mobile phone number supposedly associated with the payer telecommunications device 110. As discussed above, a mobile phone number advantageously uniquely identifies the payer 300 to the payment server 102 without the need for third party verification.

To enhance security, even when the payment server 102 uses a mobile phone number as the PAID associated with the payer telecommunications device 110, additional codes may be used to generate a GUGID. For example, payment server 102 may further use an additional type of unique short code (such as a three or four character numeric or alphanumeric code) to ensure security. This unique short code, thereafter referred to as payment server provided ID (thereafter “PSPID”), can be associated with the payer telecommunications device 110. In some embodiments, the PSPID may be changed by the payment server 102 after each transaction performed by the payer telecommunications device 110, via text message communication or via a mobile application running on the payer telecommunications device 110. In some embodiments, the PSPID may be a randomly generate number or alphanumeric code.

In some embodiments, the PSPID can be appended to the PAID (e.g., the mobile phone number (or to a portion thereof) associated with the payer telecommunications device 110) to create a composite GUGID in the form PAID.PSPID. This composite or “combination” code can improve the security of the transactions and reduce the burden on the payer because it resembles the single member group situation discussed above, in which a NULL TID or no TID is required to process the financial transaction between the payer and the payee. In the alternative, the GUGID may only include the PSPID without the PAID associated with the payer telecommunications device 110, in which case the GUGID is the PSPID. When the PSPID is used as the GUGID, the PSPID may include an equal number of digits or alphanumeric characters as the PAID (e.g., the payer's phone number). For example purposes, and without departing from the spirit and the scope of the disclosure, in the discussion below, the GUGID will be described in the context of PAID.PSPID.

It is to be understood, the GUGID (e.g., the PAID or the composite PAID.PSPID) is used herein as an attribute, much like a generic or non-globally unique GID, the location data, the duration period or validity window of the TID, and the time of the transaction discussed in previous examples (e.g., the Time Bounded and Geographically Bounded implementations). Further, the GUGID (such as the PAID or the composite PAID.PSPID) is an attribute meant to be provided by the payer 300, not the payee 302, and may be combined with other attributes (e.g., the data location, and/or the validity window, time of the transaction, etc.) to provide additional layers of security in a financial transaction. Additionally, the GID and the GUGID are primarily used in payer-initiated transactions, as opposed to payee-initiated transactions discussed in the Time Bounded and Geographically Bounded implementations.

In some embodiments, the implementation of a PSPID can prevent false alerts towards a real payer when a bad actor portraying to be the actual payer tries to impersonate the real payer by presenting the real payer's phone number in a transaction. If the payment server 102 expects to receive a PAID.PSPID code, and instead receives a PAID (e.g., the entire payer's phone number or a portion of the payer's phone number), it can block the transaction without unnecessarily disturbing the real payer with a spurious transaction notification. Thus, the implementation of a GUGID as a PAID.PSPID improves the security of the disclosed method by making it harder for bad actors to impersonate real payers even when the entire the payer's entire phone number is known.

These situations may be avoided by implementing a PSPID code that changes after every use. Thus, only the most current PSPID is available to the payer telecommunications device to be used with a PAID (e.g., the payer's phone number digits). For any bad actor, who does not have access to the payer's telecommunications device, it can become increasingly difficult to provide a valid combination of PAID.PSPID to a payee telecommunications device because the bad actor would have to guess the instant value of PSPID. The payment server 102 can be configured to reject any invalid PAID.PSPID combinations.

### Delegate Payer

In some embodiments, the PAID.PSPID combination, as a GUGID discussed above, may be implemented when a payer 300 authorizes a delegate payer (thereafter “delegate”) to perform a financial transaction on the payer's behalf. For example, this can be useful when the payer is a parent or a legal guardian and the delegate is a child or a minor, another adult family member, a helper who assists the payer with purchases, etc. In some embodiments, the delegate does not need to have a device registered with the payment server 102 or an application software installed on a device that communicates with payment server 102. In some embodiments, the delegate's may only need to own a device that can communicate with the payment server 102 via text messages, such as SMS messages. For example, the delegate may own a cell phone capable of communicating with payment server 102 via text messages.

In some embodiments, the payer 300 can be offered the option by the payment server 102 (e.g., via a mobile application running on the payer telecommunications device 110 or from a website operated by the payment server 102 and accessed by payer telecommunications device 110) to issue a voucher for a delegate who owns a delegate telecommunications device (e.g., a smart phone or a dump phone configured to communicate via text messages with the payment server 102) with an associated phone number known to payer 300. In the voucher, the payer 300 may indicate an authorization amount and the delegate's phone number. This information can be stored by the payment server 102, which proceeds to issue a GUGID in the form of: (i) the delegate's phone number as the PAID, (ii) the delegate's phone number (the PAID) and a PSPID combination (e.g., a PAID.PSPID code), (iv) a link with a QR code, or (v) any type of suitable identifier that can uniquely identify the delegate when the delegate communicates with a payee. By way of example and not limitation, the delegate, via his/her delegate telecommunications device, may receive a text message (e.g., a secure SMS) with the GUGID (e.g., the PAID.PSPID), which the delegate can then provide to the payee to complete the transaction on behalf of the payer 300. As long as the transaction amount is less than or equal to the authorized amount indicated in the voucher, the transaction may proceed within a predetermined validity window between the delegate and the payee 302 as if the delegate is the real payer. In some examples, there may be an approval step involved that requires an approval from the delegate in the form of SMS communication between the delegate and the payment server 102. The financial transaction may conclude once the delegate approves the invoice or purchase information from the payment server 102.

It is to be understood that the delegate and the payee may use additional attributes (in addition to the PAID.PSPID or GUGID attribute). For example, the payee may request from the payment server 102 that a validity window is established for the transaction, similar to the validity window for a NULL TID discussed in previous examples. In some implementations, other attributes may be used, such as a geographical location or a geofence, as discussed above. Thus, the delegate payer method described herein may be combined with the time bounded and/or geographical bounded methods described above.

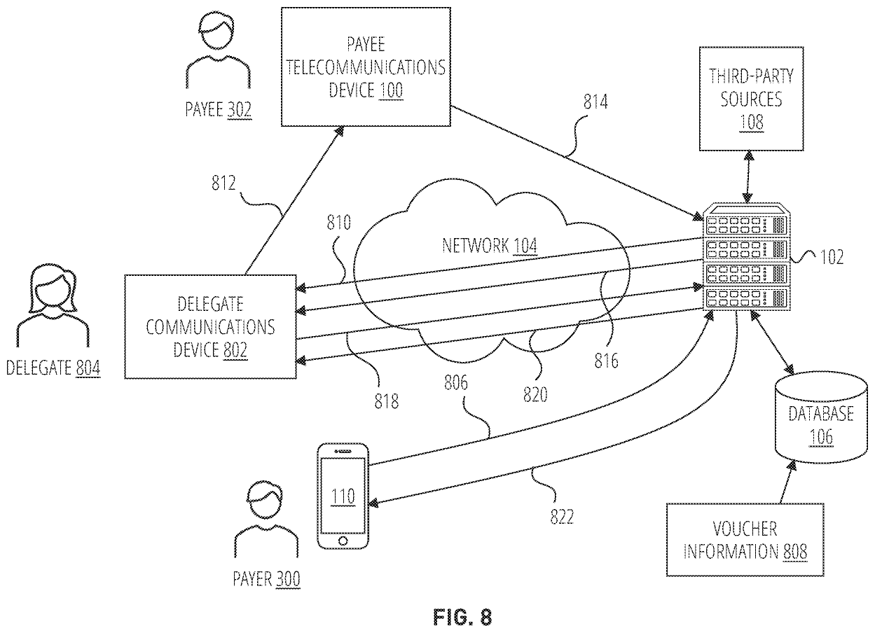

According to some embodiments, FIG. 8 describes a method for making electronic payments with the help of a delegate 804 assigned by the payer 300. The process depicted in FIG. 8 may be described as follows. Initially, the payer 300 transmits a voucher request to the payment server 102 with at least (i) an allowable transaction amount and (ii) a phone number (PAID) associated with a delegate communications device 802 owned by delegate 804. The voucher request may be communicated from the payer telecommunications device 110 to the payment server 102 via network 104, as indicated by communication link 806. Once the voucher request is received by payment server 102, the payment server 102 stores the information as voucher information 808 in databases 106 and generates a GUGID for delegate 804. The GUGID is then communicated to delegate communications device 802 via a text message (e.g., an SMS message), as indicated by communication link 810. In some implementations, communication between delegate communications device 802 and payment server 102 may be established via the network 104 or via a separate network, or via combination of networks—e.g., via the network 104 and another network (not shown).

According to some embodiments, the GUGID may be in the form of the delegate's phone number (PAID), a portion of the delegate's phone number (PAID) and a PSPID combination (e.g., PAID.PSPID), a random alphanumerical code, a link with a QR code, or any type of suitable identifier that can uniquely identify the delegate 804.

Once the GUGID is received by the delegate communications device 802, delegate 804 may communicate the received GUGID to the payee telecommunications device 100, as indicated by communication link 812. The payee 302 may then relay the GUGID, through his/her payee telecommunications device 100, to the payment server 102, as indicated by communication link 814. At this point, the payment server 102 can verify that the received GUGID corresponds to the one issued for the delegate 804, and request, via a text message (communication link 816), from the delegate communications device 802 a confirmation to release the transaction funds to the payee 302. In some implementations, the text message to delegate communications device 802 (from payment server 102) may include information such as the transaction amount, the transaction time, payee information, or any suitable information that would allow the delegate 804 to identify the transaction currently in progress.

Accordingly, the delegate 804 may confirm to the payment server 102 his/her intention to complete the purchase via text message communication, as indicated by communication link 818. Once the payment server 102 receives the confirmation from delegate communications device 802, and assuming the transaction amount is within the allowable amount identified in the voucher, the payment server 102 can release the funds to payee 302. In some embodiments, the payment server 102 may send a notification to the delegate communications device 802 and/or payer telecommunications device 110 that the transaction has been completed, as indicated respectively by communication link 820 and communication link 822.

According to some embodiments, and as described above, the payer 300 does not participate in the purchase process shown in FIG. 8. Instead, the payer 300 only provides the delegate's information to the payment server 102 via the voucher request, while the entire process is executed between the delegate 804, the payment server 102, and the payee 302 without intervention from payer 300. Further, delegate 804 does not need to register his/her delegate communications device 802 with the payment server 102 to initiate or complete purchases, neither is required to download any software applications to his/her delegate communications device 802. The only requirement for the payment method described in FIG. 8 is for the delegate communications device 802 to be able to communicate via text messaging with the payment server 102.

### Some Embodiments

Some embodiments may include any of the following:

A1. A method for making payments includes transmitting with a first telecommunications device a request for TID, a payment amount for a financial transaction, and first geographical location data to a payment server communicatively coupled to the first telecommunications device via a network, where in response to receiving the request from the first telecommunications device, the payment server is confirming the first geographical location data, generating the TID, and transmitting, over the network, the TID to the first telecommunications device. In response to receiving the TID from the payment server, the first telecommunications device is communicating the received TID to a second telecommunications device that is communicatively coupled to the payment server via the network, and in response to receiving the TID from the first telecommunications device, the second telecommunications device is transmitting the received TID and second geographical location data to the payment server over the network. Further, and in response to receiving the TID and the second geographical location data from the second telecommunications device, the payment server is comparing the received TID from the second telecommunications device to the generated TID and the second geographical location data to the first geographical location data, and in response to the received TID matching the generated TID and the second geographical location data matching the first geographical location data, the payment server is transmitting to the second telecommunications device, over the network, invoice information related to the payment amount and a payment confirmation request. According to the method, in response to receiving the invoice information and the payment confirmation request from the payment server, the second telecommunications device is transmitting an authorization order to the payment server to release the payment amount to the first telecommunications device.

A2. A system that includes a first telecommunications device, a delegate telecommunications device, a second telecommunications device, and a payment server, where the first telecommunications device is operable to transmit to the payment server a voucher request that includes a phone number associated with the delegate telecommunications device and an authorized payment amount for a financial transaction. In the system, the payment server, upon receiving the voucher request, is operable to assign and transmit, via text message communication, a globally unique group identification (GUGID) to the delegate telecommunications device, where the delegate telecommunications device, upon receiving the GUGID from the payment server, is operable to communicate the GUGID to the second telecommunications device. The second telecommunications device is operable to relay the received GUGID to the payment server, which upon verifying that the received GUGID is the assigned GUGID, is further operable to transmit, via text message communication, invoice information and a payment confirmation request to the delegate telecommunications device. Additionally, in the system, the delegate telecommunications device, upon receiving the payment confirmation request, is further operable to transmit an authorization order, via text message communication, back to the payment server to release the authorized payment amount to the second telecommunications device.

A3. A method for making payments that includes a first telecommunications device communicating to a second telecommunications device a GUGID related to a financial transaction between the first telecommunications device and the second telecommunications device, the second telecommunications device communicating the received GUGID to a payment server, and the payment server comparing the received GUGID to a stored GUGID associated with the first telecommunications device. In response to the received GUGID matching the stored GUGID, payment server is communicating to the first telecommunications device invoice information and a payment confirmation associated to the financial transaction, and the first telecommunications device communicating an authorization order to the payment server to release funds to the second telecommunications device to complete the financial transaction.

### Additional Considerations

According to some embodiments, the types of communications between the payer 300 and payee 302 or the payee 302 and a delegate, as described above in connection to the methods and systems in FIGS. 1A-B and 2-7, can be verbal, visual, electronic, or any combinations thereof. With respect to types of electronic communications, low-range, fast connection protocols may be particularly suitable, including but not limited to, Bluetooth Low Energy (BLE) and Near Field Communication (NFC) to name a few. Additionally, the communication between the payer telecommunications device 110 and the payee telecommunications device 100 may be facilitated by any suitable short range wireless electronic communication (e.g., less than about 300 feet range), including but not limited to, Bluetooth, Wi-Fi, and Radio Frequency Identification (RFID). Most, if not all, of the present day electronic devices are equipped with components that enable and use these types of communications. By way of example and not limitation, these devices can include (portable) Point of Sale (POS) terminals, smart phone devices, tablets, laptop computers, smart watches, and the like. Accordingly, the payee telecommunications device 100 may be, for example, a POS or a payment terminal, a tablet or even a smart phone device; while the payer telecommunications device 110 can be, for example, a smart phone device, a tablet, or a smart watch to name a few.

In some embodiments, the payee telecommunications device 100 may optionally be configured to communicate its device ID along with the (transient) TID to the payer telecommunications device 110. When the payee telecommunications device 100 is configured to do so, the length of the TID may be shortened. More specifically, the device ID of the payee telecommunications device 100 has to be unique so that the device ID along with the TID can form a combination that uniquely identifies the payee telecommunications device 100 and distinguishes it from other nearby payee telecommunications devices. Thus, when the payee telecommunications device 100 can determine that there are no other payee telecommunications devices that may interfere with it, the payee telecommunications device 100 can transmit a NULL (transient) transaction ID code.

Other communications channels that may facilitate the communication between the payee telecommunications device 100 and the payer telecommunications device 110 can involve cameras coupled with suitable software (e.g., cameral software and/or a payment application software). For example, the payer telecommunications device 110 may be equipped with a camera that captures the payee provided transaction ID (and/or other information if necessary), which can be either in the form of plain text or in the form of a quick-response (QR) code. Once captured, a payment application running on the payer telecommunications device 110 may use image optical recognition techniques to determine the TID being provided by the payee telecommunications device 100. Alternatively and/or additionally, communication between the payee telecommunications device 100 and the payer telecommunications device 110 can be audio-based. For example, payee telecommunications device 100 may transmit the TID (and/or other information if necessary) as an audio waveform from which the payer telecommunications device 110 can derive the TID.

In some implementations, a payment system, such as the payment systems discussed in FIGS. 1A-B and 2-7, may include multiple payment servers (e.g., a plurality of payment servers), like payment server 102. When there is a plurality of payment servers, each payment server can be identified by its own server identifier, which may be communicated to the payee by the payer to complete the above discussed transactions.

As discussed for the systems and method described in FIGS. 1A-B and 2-7, for auditing purposes as well as to comply with various regulatory requirements, the payment server 102 can be configured to persistently store (e.g., in database 106) identification information related to the payee 302 and payer 300, as well as other information or attributes such as: (i) the time of transaction (corresponding to the timestamp for the issued TID), (ii) the validity window for the issued TID or NULL TID, (iii) the payment amount, (vi) the transient TID code, (v) location data for the payee and payer, (vi) the GID or GUGID, and/or (vii) any combination thereof.

In some implementations, the time of the transaction and the (transient) TID are globally unique. In further implementations, the combination of the time of the transaction, the GID, the location data, and the TID are unique and associated with the transaction. In yet further implementations, if the combination of: the time of the transaction, the data location, and the GID are unique, then no TID is required (e.g., the TID would be NULL).

The phrasing and terminology used herein is for the purpose of description and should not be regarded as limiting.

Measurements, sizes, amounts, and the like may be presented herein in a range format. The description in range format is provided merely for convenience and brevity and should not be construed as an inflexible limitation on the scope of the invention. Accordingly, the description of a range should be considered to have specifically disclosed all the possible subranges as well as individual numerical values within that range. For example, description of a range such as 1-20 feet should be considered to have specifically disclosed subranges such as 1 foot, 2 feet, 1-2 feet, less than 2 feet, 10-11 feet, 10-12 feet, 10-13 feet, 10-14 feet, 11-12 feet, 11-13 feet, etc.

Although the concepts and principles of operation for the systems described in FIGS. 1A-B and 2-7 have been described with limited number of components for simplicity, these systems may include additional electrical and/or mechanical components necessary for their operation. Such components may include, but are not limited to, one or more computer processing units (CPUs), one or more graphics processing units (GPUs), suitable memory (e.g., RAM, FLASH), storage devices (solid state drives, hard drives, etc.), network modems for wireless and wired communications, and the like. Additionally, payer telecommunications device 110 and payee telecommunications device 100 may be GPS enabled devices, capable of connecting with other devices via Bluetooth, NFC, Wi-Fi, cellular networks, and other suitable wireless protocols to receive push notifications, different types of digital and/or analog electronic communications and signals as described herein. These additional components and functionality are within the spirit and the scope of this disclosure. According to some embodiments, payer telecommunications device 110 and payee telecommunications device 100 may also run software, such as payment software in the form of application software, to perform the functions described herein.

Furthermore, connections between components or systems within the figures are not intended to be limited to direct connections. Rather, data or signals between these components may be modified, re-formatted, or otherwise changed by intermediary components. Also, additional or fewer connections may be used. The terms “coupled,” “connected,” or “communicatively coupled” shall be understood to include direct connections, indirect connections through one or more intermediary devices, wireless connections, and so forth.

Reference in the specification to “one embodiment,” “preferred embodiment,” “an embodiment,” “some embodiments (or implementations),” or “embodiments/implementations” means that a particular feature, structure, characteristic, or function described in connection with the embodiment is included in at least one embodiment of the disclosure and may be in more than one embodiment. Also, the appearance of the above-noted phrases in various places in the specification is not necessarily referring to the same embodiment or embodiments.

The use of certain terms in various places in the specification is for illustration purposes only and should not be construed as limiting. A service, function, or resource is not limited to a single service, function, or resource; usage of these terms may refer to a grouping of related services, functions, or resources, which may be distributed or aggregated.

Furthermore, one skilled in the art shall recognize that: (1) certain steps may optionally be performed; (2) steps may not be limited to the specific order set forth herein; (3) certain steps may be performed in different orders; and (4) certain steps may be performed simultaneously or concurrently.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements).

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements).

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Each numerical value presented herein, for example, in a table, a chart, or a graph, is contemplated to represent a minimum value or a maximum value in a range for a corresponding parameter. Accordingly, when added to the claims, the numerical value provides express support for claiming the range, which may lie above or below the numerical value, in accordance with the teachings herein. Absent inclusion in the claims, each numerical value presented herein is not to be considered limiting in any regard.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

It will be appreciated by those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

Having thus described several aspects of at least one embodiment of this disclosure, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

What is claimed is:

1. A method for making payments, comprising:
transmitting with a first telecommunications device a request for a transaction identification (TID), a payment amount for a financial transaction, and first geographical location data to a payment server communicatively coupled to the first telecommunications device via a network;
in response to receiving the request from the first telecommunications device, the payment server confirming the first geographical location data, generating the TID, and transmitting, over the network, the TID to the first telecommunications device;
in response to receiving the TID from the payment server, the first telecommunications device communicating the received TID to a second telecommunications device communicatively coupled to the payment server via the network;
in response to receiving the TID from the first telecommunications device, the second telecommunications device transmitting the received TID and second geographical location data to the payment server over the network;
in response to receiving the TID and the second geographical location data from the second telecommunications device, the payment server comparing the received TID from the second telecommunications device to the generated TID and the second geographical location data to the first geographical location data, and in response to the received TID matching the generated TID and the second geographical location data matching the first geographical location data, the payment server transmitting to the second telecommunications device, over the network, invoice information related to the payment amount and a payment confirmation request; and
in response to receiving the invoice information and the payment confirmation request from the payment server, the second telecommunications device transmitting an authorization order to the payment server to release the payment amount to the first telecommunications device.

2. The method of claim 1, wherein the first geographical location data comprise geographical coordinates of the first telecommunications device.

3. The method of claim 1, wherein the second geographical location data comprise geographical coordinates of the second telecommunications device.

4. The method of claim 1, wherein prior to transmitting with the first telecommunications device the request for the TID, registering the second telecommunications device with the payment server.

5. The method of claim 4, wherein registering the second telecommunications device with the payment server comprises:
transmitting from the second telecommunications device to the payment server a device ID associated with the second telecommunications device, a phone number associated with the second telecommunications device, and a payment method; and
upon receiving the device ID, the phone number, and the payment method, the payment server linking the second telecommunications device to the payment method and storing the device ID, the phone number, and the payment method to a database.

6. The method of claim 5, wherein upon receiving the TID from the second telecommunications device, the payment server validating whether the second telecommunications device is registered with the payment server and a payment method is associated with the second telecommunications device.

7. The method of claim 6, wherein the payment server upon generating the TID, storing the TID, the payment amount, and a merchant ID associated with the first telecommunications device to the database.

8. The method of claim 7, wherein the payment server upon releasing the payment amount to the first telecommunications device, storing transaction information related to the merchant ID and the payment method used to pay the payment amount to the database.

9. The method of claim 7, wherein the payment server upon generating the TID, further creating a timestamp corresponding to a time when the TID is first generated, and storing the timestamp to the database.

10. The method of claim 9, wherein the payment server upon creating the timestamp, further defining a duration period for which the TID is active.

11. The method of claim 9, wherein the payment server upon creating the timestamp, further defining an expiration date and time for the TID.

12. The method of claim 1, wherein communicating the TID from the first telecommunications device to the second telecommunications device comprises verbal communication between a first user operating the first telecommunications device and a second user operating the second telecommunications device.

13. The method of claim 1, wherein communicating the TID from the first telecommunications device to the second telecommunications device comprises transmitting the TID via the network.

14. The method of claim 1, wherein communicating the TID from the first telecommunications device to the second telecommunications device comprises transmitting the TID via any of a Bluetooth connection, a Wi-Fi connection, and a Near Field Communication (NFC).

15. The method of claim 1, wherein the first telecommunications device corresponds to a payee telecommunications device and the second telecommunications device corresponds to a payer telecommunications device.

16. The method of claim 1, wherein in response to the received TID from the first telecommunications device not matching the generated TID by the payment server and the first geographical location data not matching the second geographical location data, the payment server transmitting to the second telecommunications device, via the network, an error message indicating a payment error.

17. The method of claim 1, wherein the TID is a transient TID that is active for a predetermined period of time.

18. A system comprising:
a first telecommunications device;
a delegate telecommunications device;
a second telecommunications device; and
a payment server,
wherein the first telecommunications device is operable to transmit to the payment server a voucher request comprising a phone number associated with the delegate telecommunications device and an authorized payment amount for a financial transaction,
wherein the payment server, upon receiving the voucher request, is operable to assign and transmit, via text message communication, a globally unique group identification (GUGID) to the delegate telecommunications device,
wherein the delegate telecommunications device, upon receiving the GUGID from the payment server, is operable to communicate the GUGID to the second telecommunications device,
wherein the second telecommunications device is operable to relay the received GUGID to the payment server,
wherein the payment server, upon verifying that the received GUGID is the assigned GUGID, is further operable to transmit, via text message communication, invoice information and a payment confirmation request to the delegate telecommunications device, and
wherein the delegate telecommunications device, upon receiving the payment confirmation request, is further operable to transmit an authorization order, via text message communication, back to the payment server to release the authorized payment amount to the second telecommunications device.

19. A method for making payments, the method comprising:
a first telecommunications device communicating to a second telecommunications device a globally unique group identification (GUGID) related to a financial transaction between the first telecommunications device and the second telecommunications device;
the second telecommunications device communicating the received GUGID to a payment server;
the payment server comparing the received GUGID to a stored GUGID associated with the first telecommunications device, and in response to the received GUGID matching the stored GUGID, communicating to the first telecommunications device invoice information and a payment confirmation associated to the financial transaction; and
the first telecommunications device communicating an authorization order to the payment server to release funds to the second telecommunications device to complete the financial transaction.

20. The method of claim 19, wherein the GUGID comprises a payer associated identification (PAID) corresponding to a portion of a phone number associated with the first telecommunications device and a payment server provided ID (PSPID) associated with the first telecommunications device.
